(19) United States
(12) Patent Application Publication
(10) Pub. No.: US 2008/0282293 A1
(43) Pub. Date: Nov. 13, 2008

(54) System and method for an event scheduler

(75) Inventors: Yiftah Frechter, Moshav Bitzaron (IL); Erez Noah Barak, Kirkland, WA (US)

Correspondence Address: Dr. D'Vorah Graeser;c/o Discovery Dispatch, 9003 Florin Way, Upper Marlboro, MD, 20772, US

(73) Assignee: 2 BE, LLC

(21) Appl. No.: 11/984,860

(22) Filed: Nov. 23, 2007

Related U.S. Application Data
(60) Provisional application No. 60/928,048, filed on May 7, 2007.

(51) Int. Cl. G06F 3/00

(52) U.S. Cl. 725/58

(57) ABSTRACT

A system and a method for event searching and scheduling for network events of various event types, including offline and online events.

This Application claims priority from U.S. Provisional Application No. 60/928,048, filed on May 7, 2007, hereby incorporated by reference as if fully set forth herein.

### FIELD OF THE INVENTION

The present invention relates to a system and a method for an event scheduler and in particular, to such a system and method in which a schedule of events is presented to a user which includes on-line and off-line events.

### BACKGROUND OF THE INVENTION

The development of communication technology and the increase in internet speed has enabled both the viewing and broadcasting of events on the internet. The internet's interactive nature allows the greater public to both broadcast and view various multimedia events as well as participate in them. Webcam output, clips, movies, music, live concerts, sporting events, televised events and the like may be viewed on the internet. Virtually anyone having access to the internet may then view or listen to the multimedia event. Furthermore, many users use a webcam to communicate with other users on various common interest topics in chat rooms, blogs, Skypecasts™ and the like that may be broadcasted on the internet for either the general public or a select private audience.

Therefore, the development of digital technology has brought television and internet closer together, in some respects fusing the experience, as events previously only available on television or radio are now also available through the internet. For example, sporting events, concerts, radio talk shows, are now readily available through the internet. The internet has also created a new type of audience interaction for classic television and radio events, as for example chat rooms are commonly used to increase audience interaction with radio talk shows in a manner that has replaced audience “call ins” to some extent. Similarly chat rooms are used for televised events to bring a talk show host or actor in direct contact with the show's audience. The internet has allowed traditional media to expand, reaching new audiences.

Internet use may be typically classified into two classes that are termed ‘Search and Surf’ and ‘Cycle Surf’. ‘Search and Surf’ refers to a user that searches for topics of interest by primarily using a search engine as the basis. ‘Cycle Surf’ refers to a user that continuously browses a set number of web sites, usually favorite sites, in a sequence.

However, as the television and internet experiences fuse, such fusion is expected to give rise to internet use or behaviors that more closely resemble passive television viewing. Passive internet use refers to a user viewing online web events based on scheduled events, accessed according to time frame, category or topic of interest.

Unfortunately, to date, no electronic programming guide (EPG) is available for all such internet events. Furthermore, no single point of reference is available that shows all types of online events. Therefore a uniform guide that indicates when and where a multimedia event or broadcasts are scheduled to take place on the internet is not currently available. Users are not aware of the many online events that are available on the internet as there is no access or single point of reference that shows schedules for such events as well as provided searching capability over the full scope and all types of events. The state of the art does not teach of such a schedule.

US Publication No. 2006167903 to Smith et al., describes a media data structure that includes both descriptive metadata, such as Electronic Programming Guide (EPG) information about a multimedia content item, and instructions for acquiring the content item. This structure is transferable as a token for representing the content item. However the application does not teach of a system that includes the event in a schedule; rather it only provides a way of viewing the event.

U.S. Pat. No. 7,065,778 to Lu teaches a method and system that uses the internet to allow a user to order and receive specific media content that are unavailable from his or her television content provider. The method searches the internet for the requested program and makes it available to the user. However this does not teach or suggest a way of compiling a list of available media data outside of the EPG and does not discuss multiple forms of media, as only televised programming is made accessible by the taught system and method.

US Publication No. 2002-099790 to Moser et al, describes a method of organizing access to various multimedia services comprising the stages of: defining a multiple axis framework; locating each said multimedia service within said framework; and allowing a user to select a desired one of said multimedia services by identifying coordinates with respect to one or more of said axes. However, Moser does not teach of a system and method that defines network based events.

Liefooghe et al describes a system for collecting media information and listing it on a webpage for viewing. However, Liefooghe et al describe a search engine for media events rather then a scheduler alerting the user of the existence of various media events.

U.S. Pat. No. 6,481,010 to Nishikawa describes a user interface to present Internet and DSS data, and more specifically to display a graphic user interface that facilitates a user's ability to access DSS (Digital Satellite System) programming, Internet information, or a combination thereof. Although internet use and TV programming are brought together, the user of the internet is only to view websites, while the scheduled programming is only available for television shows.

U.S. Pat. No. 5,883,677 to Hoffman describes a method of creating an electronic programming guide from a number of resources thereby integrating the programs available on various media types. However, Hoffman does not describe or suggest how internet media events may be discovered, categorized and integrated into a schedule form.

U.S. Pat. No. 6,684,399 to Grooters teaches a method of updating an electronic programming guide with complementary information searched and found on a network such as the internet. However, Grooters does not teach a method of composing and searching for independent events that take place over a network such as the internet that are not based on an existing electronic programming guide.

### SUMMARY OF THE INVENTION

There is an unmet need for, and it would be highly useful to have, a system and a method for locating and scheduling event information that is made available on a network including but not limited to the internet optionally providing a user a schedule of the events, a description of the event, and the location for undertaking the event. There is also an unmet need for, and it would be highly useful to have, such a system and method for online or offline events.

The background art teaches electronic programming guides as DEPG that are used to schedule and plan event viewing that take place on television or video on demand (VOD). However, available event scheduling tools only make televised events available to the public and do not utilize the offline and online event information that is made available on a network including but not limited to the internet as a primary source of event information, therefore greatly limiting the available information to the public.

The present invention overcomes these deficiencies of the background art by providing a system and method for locating and optionally scheduling network based events. Optionally and preferably the system and method of the present invention provide an interface both for viewing and editing the network schedule. According to some embodiments, both on-line and off-line events are included in the schedule.

The information available on a computer network including but not limited to the internet is vast including event information for both offline and online events. According to the present invention there is optionally and preferably provided an automated system and method for locating events within the vast amounts of information available in a network, for example including but not limited to the internet, intranet, public or private network.

A preferable and optional embodiment of the present invention utilizes a bank of filters to quickly and preferably automatically discover and find event information from a vast number of network locations. Information including but not limited to event information is available in a network to those connected to the network. However, the information itself may be presented in very diverse forms, in different data types and languages for example including Flash™ (Flex™)/Silverlight™ or similar technologies (termed herein “browser graphic technologies”), presentations, video, clips, various mark-up languages including HTML, XML and the like, PDF, graphical representations or the like. The system and method of the present invention preferably are able to automatically identify and gather event information available in network data from the various data types available on a network, regardless of its original format, data type or language. Optionally and preferably the information is organized in various formats including but not limited to single event listing on a page on the network, a tabular schedule, a list, a GANTT chart (a type of chart that illustrates a schedule), an existing electronic schedule such as Outlook®, or the like. The organized information optionally allows a user to extract the necessary information.

The system and method of the present invention optionally and preferably enables a user to identify, schedule and plan a user's time by presenting events that are available in a given time period.

Optionally and preferably the system and method of the present invention allow a user to link directly to a scheduled online event, optionally enabling the user to participate in the event using a single registration process. Similarly, optionally and preferably the event schedule of the present invention may be presented as a widget on other network locations using specific proprietary applications and/or standard applications such as web browsers.

Optionally and preferably the system and method of the present invention use a reminder system for evoking event reminders. Optionally a reminder may be implemented by various messaging mechanisms including but not limited to voice telephone communication, email, SMS (short message service) messages, instant messaging, visual reminder, mail or other physical paper reminder, or the like.

The system and method of the present invention optionally and preferably enable a user to use the schedule as web page or browsing page that indicate to a user a schedule of events that may be optionally personalized.

Optionally the system and method of the present invention enables the user to interact with the scheduler directly enabling a user to optionally add, share, remove or edit an event or event characteristics, therefore personalizing the schedule according to the present invention.

Optionally the system and method of the present invention will allow a user to edit an event or event characteristic including but not limited to sponsorship of an event.

Optionally and preferably the user may visualize and control the schedule according to the present invention using any one of a number of video, visual and/or audio platforms including but not limited to PDA, mobile telephone, computer monitor, television, any type of electronic display (whether for visual and/or audio data) or the like.

The internet scheduler according to a preferred embodiment of the present invention preferably facilitates viewing of internet based online web events by providing a user friendly schedule detailing a collection of a plurality of different types of internet events. Optionally the schedule may be personalized. Optionally the system of the present invention will provide the user with viewing recommendations based on past viewed material or similar related matters, for example a user showing interest in scientific media is presented with similar media events in the scientific area, as determined according to event and web page characteristics. Optionally the display will have an event specific display, such that an auction (for example) is displayed in a specific manner while a chat event (as another example) is preferably presented in a different manner, in which each type of display is preferably optimized for the type of event scheduled.

The event scheduler according to the present invention preferably allows a user to harness the ever changing data on a network including but not limited to the internet or the web by presenting it in an organized and preferably optimized manner. The system and method of the present invention allows the user to easily and quickly pick and choose one or more media event(s) of interest that are broadcast on the internet or through another computer network. A further optional and preferable embodiment of the present invention provides for a system and method that reminds the user of available internet events in terms of time, location, requirements and the like, or a combination thereof.

The internet based events for example may optionally include but are not limited to live broadcast events, expected podcasts, live chat room events, data premieres, web seminars, webinars and presentations either personal or public, auctions, or the like.

An event preferably has characteristic data associated with it optionally including but not limited to, name, description, category (genre), text tags, user rating, user interest, location (web address, channel), sponsorship level, advertisement, cost, availability, planned\actual event planned attendance. Preferably at least one characteristic data item is available to the user. Optionally the event data characteristics may be displayed to the user preferably upon a request, or by a personalized view of the data. Optionally the event characteristic data may be subject to a search, allowing the user to find specific events of interest as defined by the event characteristics.

Optionally and preferably the event schedule is displayed in a user friendly, easy to read format, preferably in tabulated form that preferably shows the event time vs. event location. Optionally the event information may be displayed in the form of a GANTT chart, a list, on an electronic schedule, or any other format.

Optionally and preferably the system and method of the present invention may provide a display to a user on various media display platforms for example including but not limited to a computer monitor and/or other computer display, television, PDA, iPod™, MP3 player, pager, mobile telephone, smart phone or the like. Optionally the event may be communicated to the user in print form including but not limited to newsprint, magazine, pamphlets or the like, which is preferably also included within the term “display”.

Optionally and preferably the system and method of the present invention provides for a platform for network users to link, search, select, add, remove, edit and interact with information pertaining the scheduled internet based events. Preferably the system and method according to the present invention comprises a network connection, server, remote database, and processor.

The system and method of the present invention preferably provide an internet scheduler comprising a database that is optionally updated and changed continuously as the event schedule changes. Event data and characteristics are optionally entered into the database by various mechanisms including but not limited to automated software, RSS processing, manual collection and data entry, internal preparation from the provider of the event information, any type of automated entry and/or from search engine based data.

Preferably, the internet event scheduler enables the user to perform a contextual search within the schedule abstracted by the present invention. Preferably, the contextual search enables a user to find events, using a keyword search, within the abstracted schedule. The search may be performed on the data compiled by the present invention, according to any of the data's defined characteristics. Non-limiting examples of such data characteristics are event time, event type, event characteristics, rating, price, genre or the like.

Optionally, the search results may be presented in a number of formats. For example, the contextual search results may be optionally displayed within the abstracted schedule by highlighting the event in a particular color. Optionally, the search results may be displayed in a prioritized list, optionally including a relevance score.

Unless otherwise defined, all technical and scientific terms used herein have the same meaning as commonly understood by one of ordinary skill in the art to which this invention belongs. The materials, methods, and examples provided herein are illustrative only and not intended to be limiting. Implementation of the method and system of the present invention involves performing or completing certain selected tasks or stages manually, automatically, or a combination thereof. Moreover, according to actual instrumentation and equipment of preferred embodiments of the method and system of the present invention, several selected stages could be implemented by hardware or by software on any operating system of any firmware or a combination thereof. For example, as hardware, selected stages of the invention could be implemented as a chip or a circuit. As software, selected stages of the invention could be implemented as a plurality of software instructions being executed by a computer using any suitable operating system. In any case, selected stages of the method and system of the invention could be described as being performed by a data processor, such as a computing platform for executing a plurality of instructions.

Although the present invention is described with regard to a “computer” on a “computer network”, it should be noted that optionally any device featuring a data processor and/or the ability to execute one or more instructions may be described as a computer, including but not limited to a PC (personal computer), a server, a minicomputer, a cellular telephone, a smart phone, a PDA (personal data assistant), a pager. Any two or more of such devices in communication with each other, and/or any computer in communication with any other computer, may optionally comprise a “computer network”.

An event may collectively or individually refer to any event taking place on a network including but not limited to the internet and may optionally and preferably include but is not limited to at least one or a combination of, a live broadcast event, a podcast, chat room event, data premiere or web seminar.

The term “live broadcast event” in the context of this application includes but is not limited to events that are broadcast on the internet at the time of their occurrence and hence are “live”. Such an event may optionally be made available in whole or part on the internet at a later time. Optionally these events maybe broadcast live on one or more network locations or channels, for example a sporting event or concert may be made available on a plurality of broadcasting channels including the internet and TV.

The term “podcast” in the context of this application includes but is not limited to daily, weekly or other periodic events that are available on a regular schedule, such as a newscast. Alternatively they may be available for a single transmission or repeated transmissions of the same material.

The term “live chat room event” in the context of this application refers to planned events taking place in a chat room. Optionally these events may be hosted by a host. For example such an event may for example include but is not limited to a reality show contestant chatting with fans after a show.

The term “data premiere” refers to a scheduled event for broadcasting data, including but not limited to sporting event results, live scores, winning lottery numbers, online ticket availability or the like.

The terms “web seminars”, “web presentations” or “webinars” refer to scheduled events for broadcasting a seminar or presentation. Optionally this type of event may include a “personal” event such as a live session, which is an individual presentation on a network via a live event made available to a specific group of users only, for example including but not limited to a university lecture, professional development seminar, trade show presentation. The event may optionally use webex technology that may include audio and video transmission. Similarly the seminar may be “public” wherein a presentation is given to the general public over the internet optionally using webex technology to present and deliver the presentation that optionally may include both video and audio.

The term “event characteristics” within the context of this application refers to characteristic descriptive terms that categorize the scheduled event. The descriptive terms may for example include but is not limited to name, description, category (genre), text tags, user rating, user interest, location (web address, channel), sponsorship level, advertisement, cost, availability, expected or actual attendance.

The terms “web channel”, “web hosting pages” or “web hosting locations” refer to an interface available through the network that broadcasts an event and is accessible to users connected to the network.

Online events are referred to within the context of this application as events that take place within a network including but not limited to the internet while a user in connected to the network.

Offline events are referred to within the context of this application as events that do not take place on a network or events that do not require a user to be connected to a network. Preferably, offline events include those events at which the physical presence of the user is required for the user to be able to view and/or participate in the event. This latter type of event is not currently available as part of an overall schedule which also includes online events. Including both types of events in a combined schedule provides more information to the user and also allows the user to compare between the different types of events.

Personal events are referred to within the context of this application as events that are of particular interest to a user and are scheduled on an electronic schedule system for example including Outlook® of Microsoft Ltd, PDA, or on a network based schedule. Personal events may be either offline or online, preferably including events that are particularly important to the user which have a defined date that optionally require the user's involvement. For example, an offline event such as a birthday party has a defined date; the user cannot attend the party after it has already occurred. Similarly, an online personal event for example may include a live chat room event having a defined date in which the user would like to actively participate. More preferably, a personal event is an event with which the user is directly or personally involved.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic block diagram of an internet based event schedule according to the present invention;

FIG. 2 is a schematic block diagram of the system according to the present invention;

FIG. 3A-B are schematic block diagrams of the system according to the present invention;

FIG. 4 is a schematic block diagram of the exemplary events abstracted by the system according to the present invention;

FIG. 5 is a schematic block diagram of the filtered information according to the present invention;

FIG. 6 is an exemplary method according to the present invention comprising the stages to produce an internet schedule;

FIG. 7 is an exemplary method according to the present invention comprising the stages to produce an event schedule;

FIG. 8 is an exemplary method for optical processing according to the present invention;

FIG. 9 is an exemplary method for logically examining the data according to the present invention; and

FIG. 10 is an exemplary display of an illustrative user interface (GUI) of the system and method according to the present invention.

### DESCRIPTION OF THE PREFERRED EMBODIMENTS

The present invention is of a system and a method for an event scheduler, providing a user with a schedule for various network based events preferably including but not limited to the internet. According to some embodiments, both network based events and “offline” events are included in the schedule.

The principles and operation of the present invention may be better understood with reference to the drawings and the accompanying description.

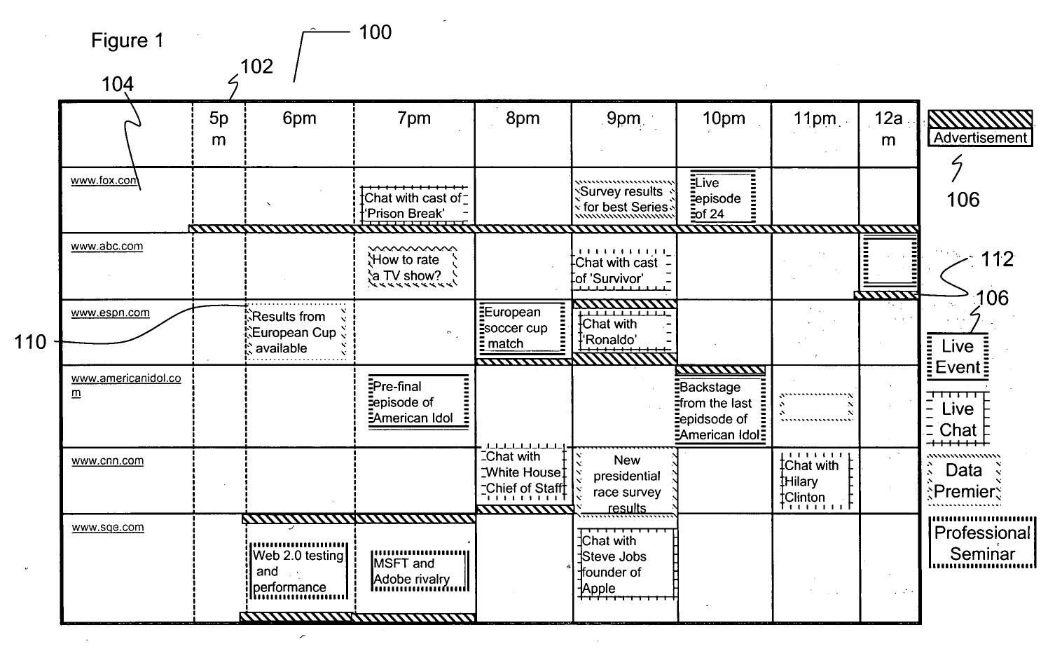

Referring now to the drawings, FIG. 1 shows an exemplary illustrative graphical representation of an event schedule 100 according to an optional but preferred embodiment of the present invention, for preferably providing an event schedule for both online and offline events. Event schedule 100 is an exemplary depiction of the schedule, based on future events, where optionally and preferably a plot of time frame 102 versus event location 104 is produced, more preferably with a plurality of time slots 110. Time frame 102 may optionally and preferably be varied to control the view of schedule 100 such that the displayed events may be presented over any time span including but not limited to events occurring with a 24 hour period, a year, a month or an hour, or any other time period. Optionally and preferably a user may control and vary time frame 102 to display schedule 100 in various formats.

Optionally the user may further control the schedule's display format for example including but not limited to a GANTT chart, tabular format or a list that is optionally and preferably controllably organized or prioritized according to at least one parameter. Optionally and preferably the user may also control where the schedule is displayed including but not limited to a personalized calendar for example including an Outlook®) calendar, PDA calendar, online calendar, Google® online calendar, any other electronic calendar or the like. Optionally the display of the event schedule 100 of the present invention may optionally and preferably be controllably altered depending on the platform used to display the events. The platform that displays the search results may optionally include but is not limited to a PDA, computer, mobile telephone, smart telephone, MP3 or other music or video player, a pager or the like. Event locations 104 depict the location wherein a scheduled event takes place, optionally including but not limited to a website, chat room, blog, TV, radio, stadium, opera house, arena, concert hall, any other physical location or the like.

The order in which event locations are presented on schedule 100 may optionally and preferably be variably controlled by the system of the present invention. Optionally the event listing is controlled according to at least one parameter including but not limited to event time, user rating, channel size, channel rating, relevance or the like.

Time slot 110 is a specific depiction of an event or events that are scheduled to take place at a particular time at a particular location. Optionally and preferably each time slot 110 presents an event including but not limited to data premiere, live cast, podcast, live chatroom event, Massive Multiplayer Online games (MMO), interactive games or the like.

Optionally and preferably schedule 100 also displays advertisements 112 that may optionally and preferably be controllably spread throughout schedule 100, optionally and more preferably utilizing the different time slots 110 to display advertisements. Preferably display spot 112 may optionally be utilized for bookmark placement and/or sponsorship affiliation, thereby allowing users to share events.

Optionally and preferably schedule 100 is displayed in a simple ready to use format that would provide a user the required information at a glance. Optionally as for this example time slots 110 may be color coded in order to make schedule 100 user friendly and easy to read, therefore for this example, schedule legend 106 shows the different color coding used within the different time slots 110 displayed on schedule 100.

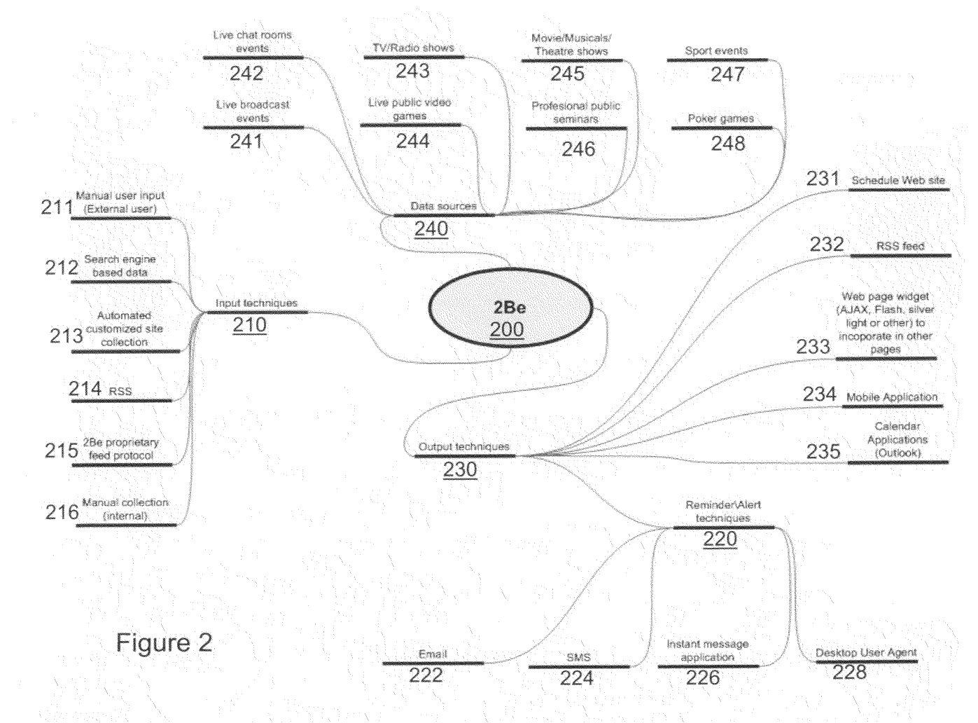

FIG. 2 shows the internet scheduling system 200 according to the present invention. System 200 comprises a plurality of input technologies 210 for receiving input events, preferably including but not limited to user data entry 211, search engine 212, automated site collection 213, Rich Site Summary (RSS, also referred to as Really Simple Syndication) module 214, a proprietary and/or customized protocol 215, and a manual data entry 216 input. Optionally and preferably automated site collection 213 uses a bank of filters to obtain event details from a network and/or from a resource on the network, such as a database (not shown). Optionally RSS module 214 (or another type of technology) is used to convey only the changes that have taken place in a network location. By “changes” it is meant any altered information, updated information or new information, including with regard to new and existing events. Therefore any information that has changed or updated, and/or newly presented, in a given timeframe, including with regard to existing events and new events, will preferably be quickly obtained using the RSS module 214 of the present invention. Proprietary module 215 optionally and preferably chooses a suitable input module of the input technologies 210 to use with a particular network location, optionally including a proprietary protocol as described in greater detail below.

Optionally and preferably input technologies 210 are used to abstract data from one or more of a plurality of sources shown collectively as data sources 240. Examples of data sources 240 optionally include but are not limited to live broadcast events 241, live chatroom event 242, TV/Radio shows 243, live/public video games 244, theatrical events 245, seminars 246, sporting events 247, and poker game 248. The input data 230 is classified using input technologies 210 according to the event type, thereby producing an output 230.

Optionally and preferably output 230 may preferably be displayed to the user in various formats, including but not limited to schedule web site 231, RSS feed 232 as is known in the art, web page widget 233, Mobile application 234 and calendar application 235. Preferably and optionally another form of output 230 includes but is not limited to reminders or alerts 220 that may optionally come in the form of any type of messaging, including but not limited to email 222, SMS 224, instant message 226, or user desktop agent 228 or the like.

Preferably web page widget 233 of the present invention is optionally made available to partner publishers or network locations to include the scheduled information of the present invention in their web site. Optionally widget 233 may take the form including but not limited to Flash™, AJAX, Silverlight™ or the like for implementation in a sister site. For example, widget 233 provides information taken from and/or related to a partner network location, for example with a miniature version of the schedule of the present invention. Optionally widget 233 is embedded at the partner's network location's interface as a miniature version of the event calendar according to the present invention. Preferably, the event information depicted in widget 233 is controlled by the system of the present invention, therefore optionally and more preferably widget 233 is updated as the schedule of the present invention is updated.

Internet scheduling system 200 optionally and preferably provides the user with a reminder alert module 220 that functions to alert the user about an upcoming chosen event. Optionally the alert module 220 is implemented using software or hardware to produce the alert.

For example, internet scheduling system 200 optionally and preferably gathers data using input technologies 210. Search engine 212 of internet scheduling system 200 preferably searches through one or more data sources 240 for one or more events. For example search engine 212 may optionally find an event in the form of a live broadcast 241 (such as a concert for example). Search engine 212 may also optionally find that following the concert, the artist is planning to chat with fans in the form of a live chatroom event 242, thereby exemplarily producing two consecutive events that are dependent on each other. Accordingly, data source module 240 optionally and preferably uses the concert data to evoke two events on internet schedule 200, including a live broadcast 241 of the concert and a chat room broadcast 242 following the concert.

Optionally and preferably this information is scheduled and updated by output module 230 in any suitable output format, such as for example schedule website 231, as well as in a corresponding partner website in the form of widget 233. Optionally and preferably output module 230 allows a user to view a description of the scheduled event on the produced schedule web site 231 calendar, and to then sign up to view the concert. Optionally reminder module 220 sends the user one or more reminders prior to the event, preferably as requested by the user, more preferably through a plurality of messaging mechanisms. Optionally reminders 220 may exemplarily be implemented to include a reminder one week prior to the event with an email 221 while a few hours prior to the scheduled event an SMS 224 is sent, for example.

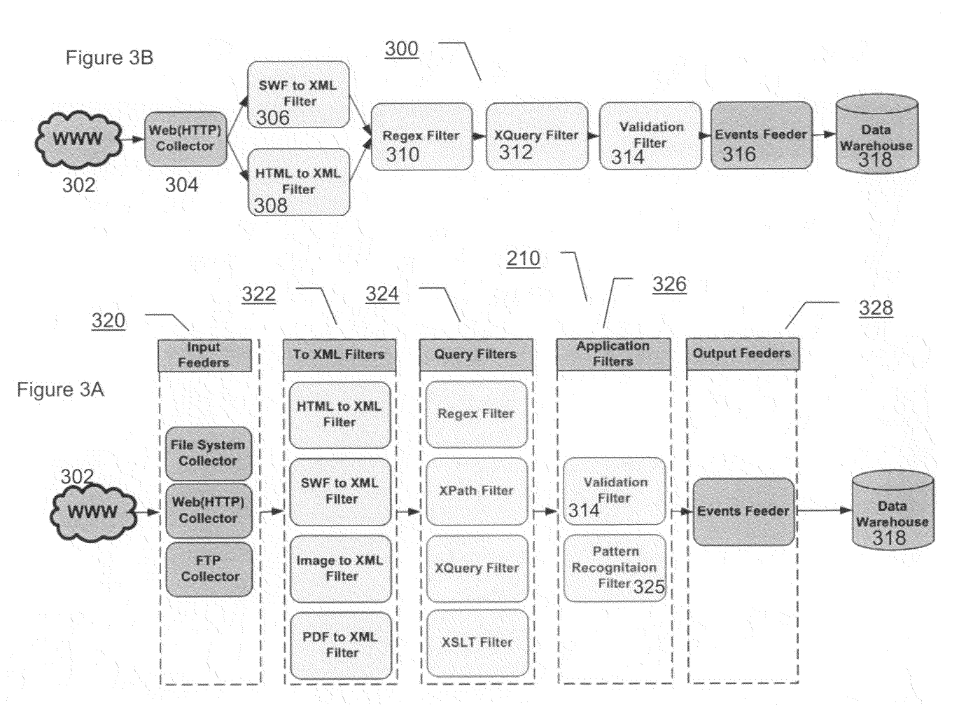

The information depicted in the example above is preferably abstracted by using a bank of filters able to gather the relevant information from even a large amount of information available on a network, for example including the internet. FIGS. 3A and 3B provide further details of the input technique module 210 of FIG. 2 showing how the information is obtained from a network.

FIG. 3A shows an exemplary embodiment of input module 210 in greater detail. Input module 210 preferably uses a network connection 302, preferably including but not limited to a connection to the internet, to access and to draw event information using input feeders module 320. Input feeders module 320 preferably comprises a plurality of input sources, more preferably including a mark-up language collector or “web” collector (described in greater detail below with regard to FIG. 3B), a FTP collector for obtaining information through the file transfer protocol and a file system collector for obtaining information from one or more file systems. Optionally, the FTP collector is used when gathering a large amount of data that is not suitable for other mark-up language protocols.

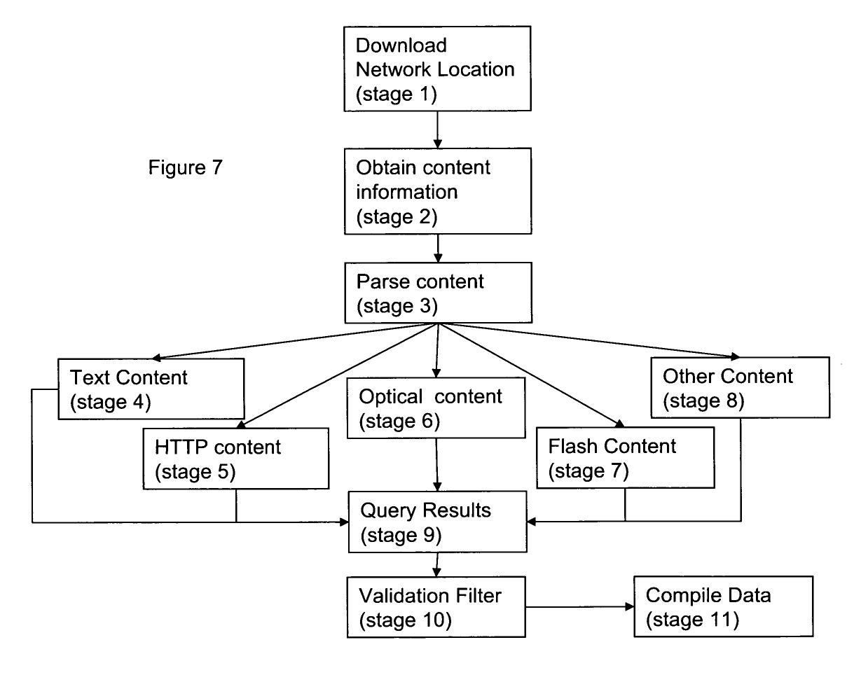

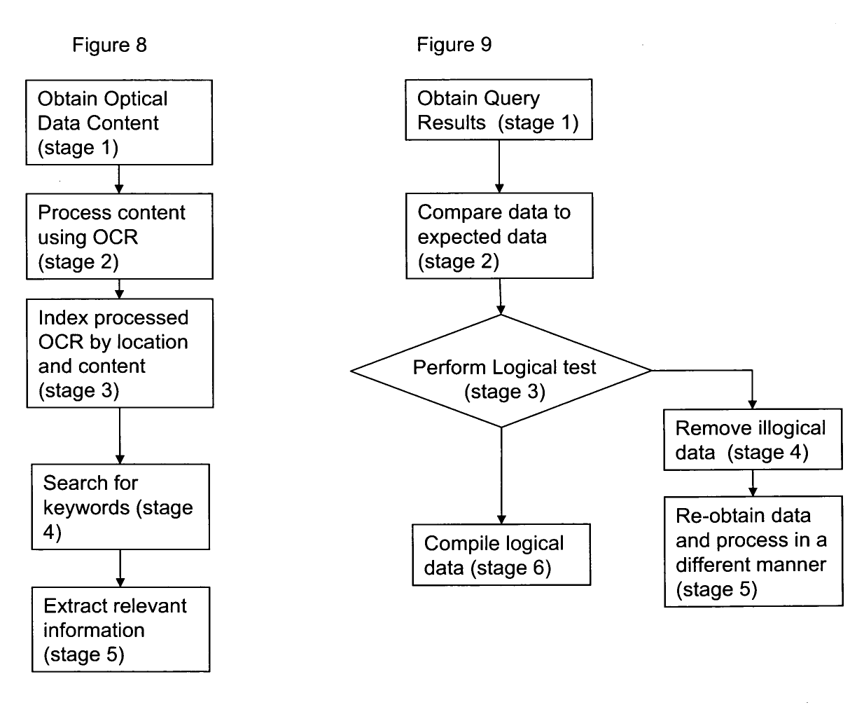

The input information is preferably later filtered using a filter bank 322 comprising a plurality of different filters. Preferably the filters function to filter the available information and to change the format to a common format, which for the purpose of this example is XML (extended mark-up language) but could optionally be any type of common format and/or language. Four exemplary filters are shown for the purpose of description only and without any intention of being limiting: an HTML to XML filter, a SWF to XML filter, an image to XML filter and a PDF to XML filter. The first two filters are described in greater detail with regard to FIG. 3B; the third filter, the image to XML filter, is described in greater detail with regard to FIGS. 7 and 8. The PDF to XML filter changes the Portable Document Format (PDF) of Adobe Systems Inc to the XML format. Such a conversion is well known in the art; in fact, many off the shelf programs are available to perform such a conversion process. As examples only and without any intention of being limiting, such programs include ABC Amber PDF Converter (ProcessText Group) and software available through Data Conversion Laboratory, Inc.

The filtered information is then optionally further queried with query one or more query filters 324. Four query filters 324 are shown for the purpose of illustration only and without any intention of being limiting: a Regex filter, an XQuery filter, an XPath filter and an XSLT filter. The first two filters are described in greater detail with regard to FIG. 3B. The term “XPath” refers to XML Path Language, which is a language for searching through XML and/or for navigating through an XML document. Such a filter could easily be constructed by one of ordinary skill in the art and so is not addressed further.

XSLT refers to Extensible Stylesheet Language Transformation; it is a language which is used to convert an XML document into another XML document or into another format which is recognized by a web browser, such as HTML for example. Again, such a filter could easily be constructed by one of ordinary skill in the art and so is not addressed further.

The obtained data is then preferably validated using one or more application filters 326, preferably and optionally ensuring that the abstracted data has one or more characteristics of the expected data. The validated data is then optionally and preferably organized into events using an output module 328. Optionally and preferably the output schedule is then optionally and preferably stored in database 318. Database 318 stores event information to be displayed in the internet schedule of the present invention.

Application filter 326 optionally and preferably includes a validation filter 314 and a pattern recognition filter 325. Optionally and more preferably validation filter 314 validates data that is gathered from network locations that are associated with system 200 of the present invention, preferably ensuring that the information gathered has one or more expected characteristics. Optionally the validation process functions to make certain that the layout, prerequisite field information, and/or one or more other characteristics of the associated network location have not changed, therefore insuring that the obtained data has the expected characteristic(s). Pattern recognition filter 325 is preferably used for network locations that have not been previously associated with system 200, optionally and preferably gathering information from the network location without prior knowledge of the information and/or its format at that network location.

FIG. 3B shows a specific instance of FIG. 3A where events are gathered from network connection 302, shown as an internet “cloud”. Data is collected using http data module 304 for preferably gathering data from web pages (mark up language documents) available through network connection 302. The http data collected with http data module 304 is then optionally filtered using SWF (flash) to XML filter 306 or html to XML filter 308. SWF to XML filter 306 operates by converting the known flash file format, also referred to as “Flash”, of Macromedia Inc, to XML. Various such converters are known in the art. The SWF format features a header, which includes such information as the frame size, frame rate and total number of frames in the file, which is also referred to as a “Flash movie”. The header is followed by a series of tagged data blocks, all of which share a common format. There are two basic types of tags: control tags and definition tags. The former are used to control the behavior of the movie, while the latter define the content of the movie, including the shapes, text, bitmaps and sounds that are used in the movie. This information is then extracted to convert the movie to a static XML representation of the data contained therein.

HTML to XML filter 308 may optionally be selected from any such converter that is known in the art, as both HTML and XML are mark up languages and so follow similar rules and have similar structures.

Filters 306 or 308 optionally and preferably gather event characteristics optionally including but not limited to event name and event time, location, duration or the like. The filtered data is optionally and preferably further queried to attain the required information optionally using a Regex filter 310. Optionally and preferably following Regex filter 310, XML data is further filtered using XQuery filter 312 to obtain the pertinent event characteristics. Validation filter 314 is then optionally utilized to further ensure that the event and event characteristics are as expected. Optionally and preferably once all event characteristics have been found by data collector 304 and filtered by a bank of filters 306 to 314 the event is organized by event feeder 316 that optionally and preferably gathers and packages the event specific information for storage in database 318.

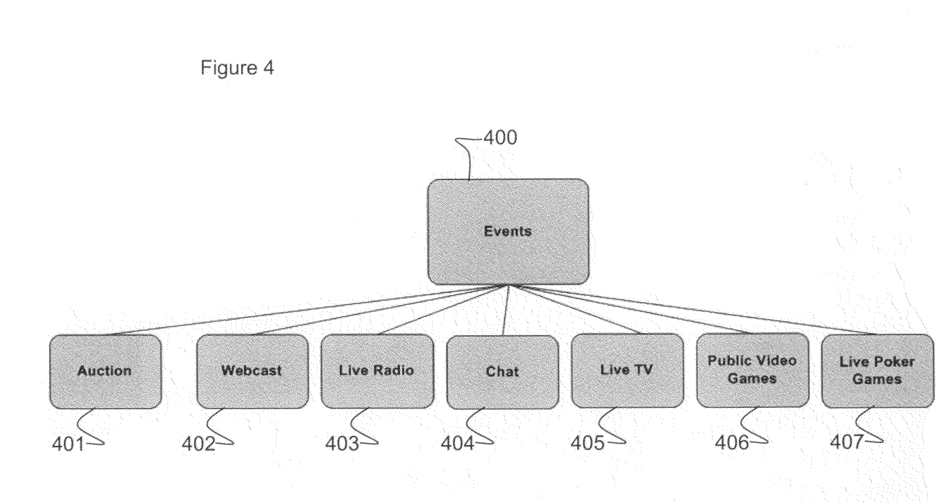

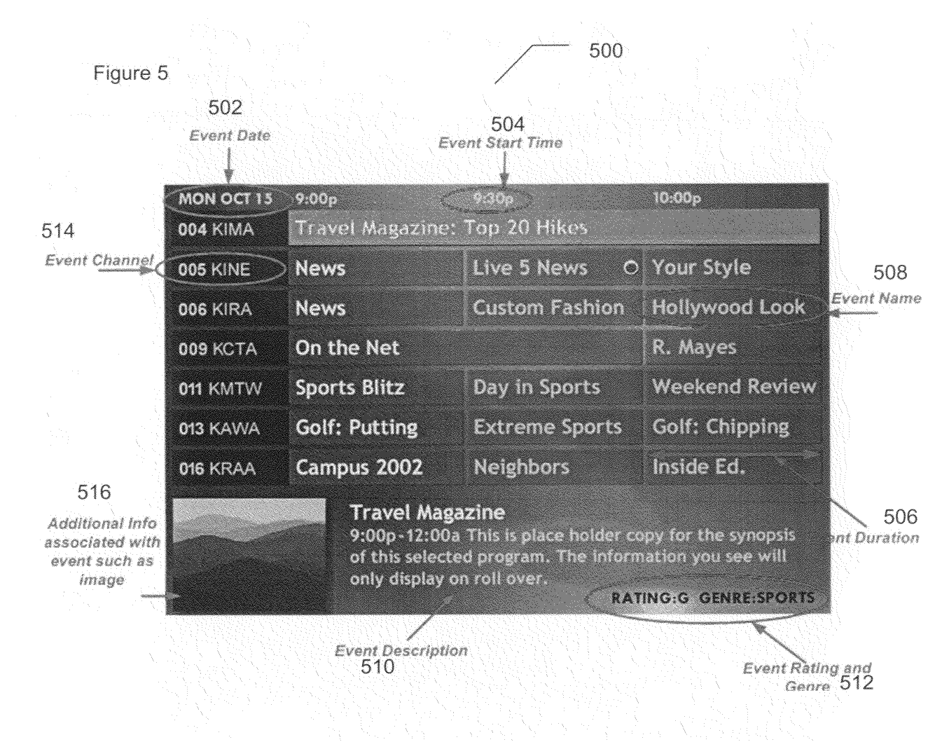

The bank of filters shown in FIGS. 3A and 3B preferably obtains information optionally and preferably about events from network locations connected to a network. FIG. 4 further shows non-limiting examples of the type of events 400 that may be abstracted with the system and method of the present invention. The event information optionally and preferably includes details regarding events optionally including but not limited to auctions 401, webcast 402, live radio 403, chat 404, live TV 405, public video games 406, live poker game 407 or any other type of on-line game or event. Optionally and preferably the user may define a user specific event type. Each event type requires particular information that is specific to it; for example an auction event is described differently from a chat, therefore the auction event module 401 preferably and optionally functions to specifically recognize auctions and auction like events. Similarly, the event modules are geared to abstract information related to their event type. Although event types 400 may be different in some aspects, all events typically share one or more common features that may be used to describe all of them, for example including but not limited to location, starting time, and duration. An example of abstracted information that was obtained from a network location is shown in FIG. 5.

FIG. 5 shows an exemplary event data 500 that may optionally be abstracted by the system and method of the present invention. Data 500 may be in various forms including but not limited to http, flash, image, PDF or the like, in which the previously described bank of filters was used to abstract event information. Optionally if data 500 is in the form of an image, an optical character recognition (OCR) processor and filter would be applied to abstract the necessary data, including but not limited to event date 502, start time 504, duration 506, event name 508, event description 510, event rating or genre 512, event location or channel 514 and miscellaneous information 516 (see FIGS. 7 and 8 for more information). Miscellaneous information 516 may optionally include additional information associated with the event to better describe the event; for example if the event is an auction 401, then additional data 516 may optionally be an image of the item being auctioned. Preferably individual event types may have a customized display according to one or more characteristics of the event type. For example a sporting event may optionally and preferably be displayed in a manner conducive to the sporting event itself, while a lecture or presentation may optionally be presented in a manner specific to the lecture or presentation.

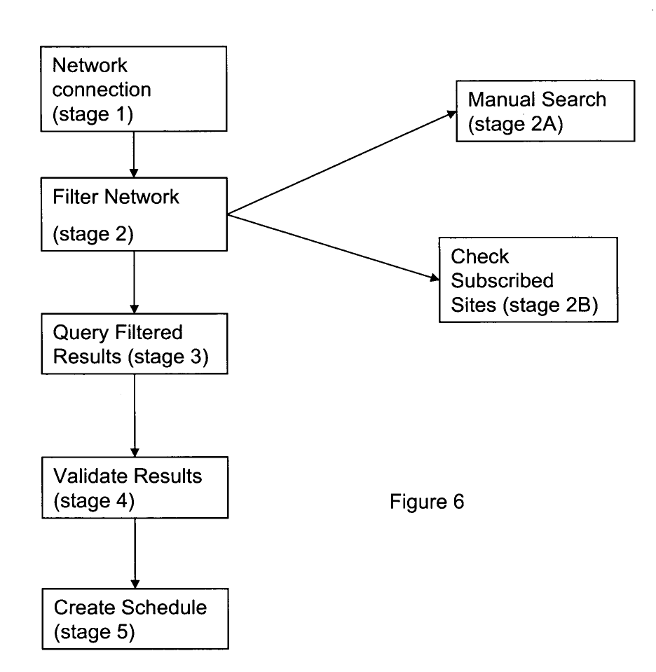

FIG. 6 shows an optional method according to the present invention comprising the stages to produce an internet schedule according to the present invention. In stage 1 a network connection is established for abstracting event information. In stage 2 data is abstracted by filtering the network for data. Optionally the data may be abstracted using a manual search of the network as in stage 2A for general information that may be found through the network connection. Optionally (and alternatively or additionally) in stage 2B, a network location that subscribes and/or belongs to and/or is associated with the system of the present invention may provide event information. Once the data is abstracted it is optionally queried in stage 3 to obtain the necessary event details. The information is then preferably validated in stage 4 to ensure that the details abstracted in fact correspond to the information expected and are logical, for example that the starting time of the event is prior to the event's end time. Preferably the schedule is created in stage 5; optionally and preferably it is then published by various means including in a paper format or electronic format.

FIG. 7 shows a still further optional method according to the present invention comprising the stages to produce an event schedule according to the present invention. In stage 1 the contents of a network location are preferably obtained via a network connection that preferably enables the system of the present invention to abstract the various type of files and formats enclosed therein. In stage 2 the content data contained within a network location is preferably obtained, and later parsed in stage 3 preferably according to one or more data types. In stage 3 the obtained data is optionally parsed into various data types optionally including text contents, http content, optical (image) content, flash content or other content type.

Data from a network location comprising various data types is preferably and optionally parsed into the different types in stage 3 while the different types of parsed data are then individually processed in stages 4-8. Text data is optionally parsed in stage 4, http (or other mark-up language) data is optionally processed in stage 5, optical (image) content is processed in stage 6, flash content is processed in stage 7, while other data types are optionally processed in stage 8. Optionally and preferably stages 4-8 are preformed simultaneously and/or in any type of sequential order. In stage 9 the different processed data is queried and combined, preferably providing an overview of the event information depicted in a network location. The query results are then optionally further processed with a validation filter in stage 10, preferably ensuring that the data abstracted from the network location is valid and logical. Preferably following the validation process of stage 10 the data is compiled, optionally and preferably forming an event schedule.

FIG. 8 shows a still further optional method for obtaining information from a network location comprising optical (image) data, providing further details of the optical content processing of stage 6 of FIG. 7. In stage 1 the optical data is obtained from the network location, optionally in the manner described in FIG. 7 in stages 1-3. In stage 2 the optical data is preferably processed using an optical character recognition (OCR) method as is well known and described in the art, wherein the optical data is converted to text data. Preferably once the OCR process is completed, the converted data is optionally and preferably indexed in stage 3. Optionally and preferably the processed data is indexed by content, for example by alphabetizing the data. Optionally the data may be indexed by location of where it was found in the original data format.

The indexed data may then optionally and preferably be searched for keywords in stage 4, where optionally a keyword search is performed to extract the event information. Optionally in stage 4 the data may be searched based on location in the original optical data form, particularly for example if the format or layout of the image data is known. In stage 5 the relevant information is optionally and preferably extracted for further processing, for example as in stages 9-11 of FIG. 7.

FIG. 9 shows in more detail the operation of the validation filter described in stage 10 of FIG. 7. In stage 1 the query result data is obtained and is then preferably compared to the expected data characteristic(s) in stage 2. Optionally in stage 3 the compared data is examined by a logical test to test if the compared data is sufficiently different or similar to one or more expected data characteristic(s), optionally a threshold may be used to compare the data. Data that is deemed to be logical and passes the logical test of stage 3 is then preferably processed further in stage 6 to create the event calendar of the present invention. Data that does not pass the logical test of stage 3 optionally undergoes further processing in stage 4, such that the illogical data is preferably removed. Optionally in stage 5, data from the network location that provided the illogical data is reprocessed, optionally and preferably in a different manner, so as to obtain logical information from the network location.

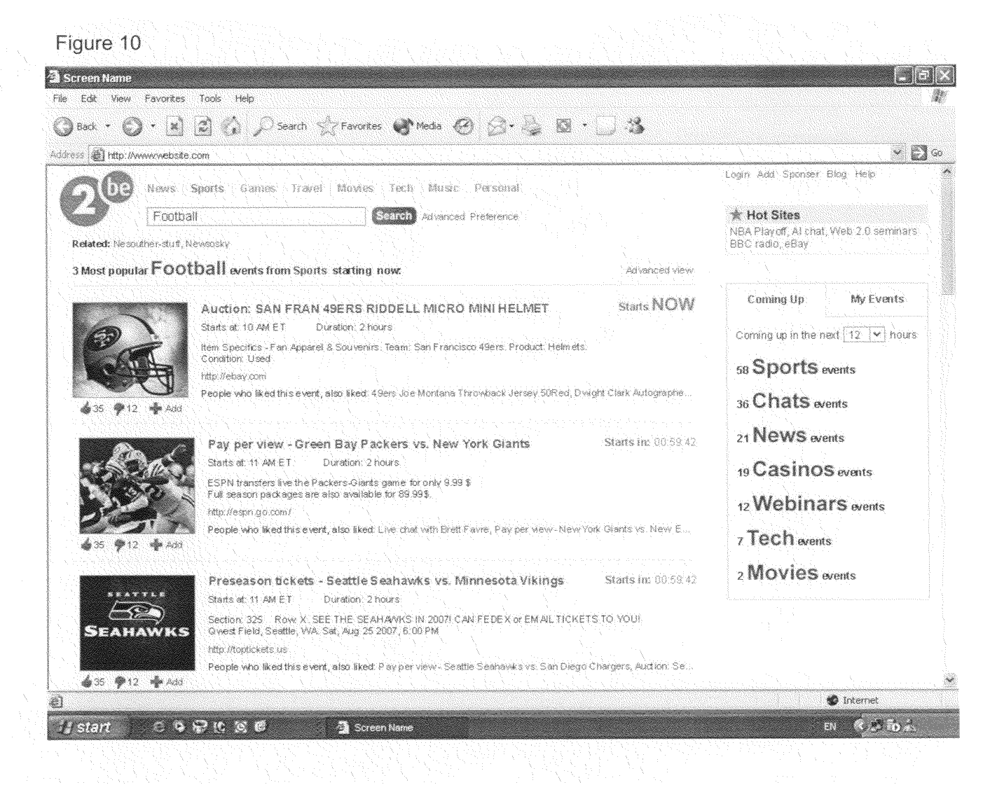

FIG. 10 shows an exemplary non-limiting user interface of the system and method of the present invention where events are searchable and presented in a list format.

While the invention has been described with respect to a limited number of embodiments, it will be appreciated that many variations, modifications and other applications of the invention may be made.

What is claimed is:

1. A system for detecting event data over a network, comprising:
a network connection to the network for obtaining the event data;
at least one filter for abstracting the event data; and
a display of the event data;
wherein event data for a plurality of events is displayed in a combined schedule and wherein at least one event is on-line and at least one event is off-line.

2. The system of claim 1 wherein the filter further comprises a pattern recognition filter for analyzing the event data according to a pattern.

3. The system of claim 2, wherein the filter further comprises a validation filter for validating the abstracted event data.

4. The system of claim 1 wherein the filter is a data filter selected from the group consisting of OCR filter, XML filter, RSS filter, PDF filter and a HTML filter.

5. The system of claim 4, further comprising a query filter for querying output from said data filter.

6. The system of claim 1 wherein the event comprises a starting time and duration.

7. The system of claim 1 further comprising a reminder system for reminding a user about an event.

8. The system of claim 7 wherein the reminder system issues a reminder selected from the group consisting of email, SMS, voice telephone communication, instant message, visual reminder, physical paper reminder and a desktop agent.

9. The system of claim 1, wherein said at least one offline event comprises an event at which the physical presence of a viewer is required.

10. The system of claim 1, wherein said display comprises at least one of a physical paper display or an electronic display.

11. The system of claim 10, wherein said electronic display is selected from the group consisting of a PDA, a mobile telephone, computer monitor, television.

12. The system of claim 1, wherein said network connection further comprises an input module for receiving the input data, said input module being selected from the group consisting of user data entry, search engine output, automated site collection, RSS feed, a customized protocol or manual data entry.

13. A method for producing a network based event schedule, comprising:
searching through a network for data about at least one event;
converting the data from a previous data format to a common data format; and
displaying the data about the event in the event schedule;
wherein said previous data format includes a visual data format.

14. The method of claim 13, wherein said visual data format includes at least one of a video data format, an image data format, a browser graphic technology format, a presentation, a mark-up language format, PDF or a graphical representation.

15. The method of claim 14, wherein the event comprises one or more of a live broadcast event, expected podcast, live chat room event, data premiere, web seminar, webinar, presentation, auction or interactive game.

16. The method of claim 15, wherein the event has a customized display according to one or more characteristics of the event type.

17. A method for producing a network based event schedule, comprising:
searching through a network for data about at least one event;
converting the data from a previous data format to a common data format;
validating converted data in said common data format according to at least one expected data characteristic; and
if validated, displaying the data about the event in the event schedule.

18. The method of claim 17, further comprising:
Searching through the data according to a contextual search for a user.

19. The method of claim 18, wherein said contextual search is performed according to one or more of event time, event type, event characteristics, rating, price, genre of event, name, description, text tags, user rating, user interest, location, sponsorship level, advertisement, cost, availability.

20. The method of claim 17, further comprising:
enabling a user to participate in the event using a single registration process.

21. The method of claim 17, wherein the event schedule is displayed as a widget.

22. The method of claim 17, further comprising sending a reminder according to a mechanism selected from the group consisting of voice telephone communication, email, SMS (short message service) messages, instant messaging, visual reminder, physical paper reminder and a user desktop agent.

23. The method of claim 17, wherein said displaying comprises providing the data on at least one of a physical paper display or an electronic display

24. The method of claim 23, wherein displayed data includes one or more of event time, event type, event characteristics, rating, price, genre of event, name, description, text tags, user rating, user interest, location, sponsorship level, advertisement, cost, availability.

25. The method of claim 17, wherein displayed data includes an advertisement.

26. The method of claim 17, wherein the data is obtained from a network source and wherein said validating said converted data comprises determining whether said converted data has an expected data characteristic including one or more of data layout or prerequisite field information, or a combination thereof, associated with said network source.

27. The method of claim 26, wherein said determining whether said converted data has an expected data characteristic further comprises examining said converted data according to a logical test to determine whether said converted data is sufficiently similar according to a threshold.

28. The method of claim 27, wherein said determining whether said converted data has an expected data characteristic further comprises reprocessing converted data that fails to meet said threshold.

29. A method for producing a network based event schedule for a user, comprising:
searching through a network for data about at least one event;
converting the data from a previous data format to a common data format; and
displaying the data about the event in the event schedule;
wherein said at least one event is indicated as a personal event for the user.
